(19) United States
(12) Patent Application Publication
(10) Pub. No.: US 2002/0000139 A1
(43) Pub. Date: Jan. 3, 2002

(54) TOOL FOR BREAKING A VACUUM IN A PRESERVING JAR CLOSED WITH A SCREW CAP

(76) Inventor: HELGE BRIX HANSEN, KALVEHAVE (DK)

Correspondence Address: ANTONELLI TERRY STOUT & KRAUS, 1300 NORTH SEVENTEENTH STREET SUITE 1800, ARLINGTON, VA, 22209

(21) Appl. No.: 08/889,328

(22) Filed: Jul. 8, 1997

Related U.S. Application Data
(63) Continuation-in-part of application No. 08/684,621, filed on Jul. 22, 1996, now abandoned.
(63) Continuation of application No. 08/302,484, filed on Sep. 12, 1994, now abandoned.

(30) Foreign Application Priority Data
Mar. 11, 1992 (DK) 010892

(51) Int. Cl. B67B 7/16

(52) U.S. Cl. 81/3.57

(57) ABSTRACT

The tool is provided with an oblong handle (1), which at one end has a portion (5) for engaging the cap (7) of a preserving jar (8), and a jaw (2) for engaging the lower edge of the cap. The mouth of the jaw is turned away from the other end of the handle, and between the free end (3) of the jaw and the portion (5) for engaging the cap (7) a concave, circular cylindrical guide slot (6) is provided said guide slot (6) guiding the tool into position against the rim of the cap in such a way that the jaw grips the lower edge of the cap, after which a slight lifting of the handle brings about an elastic deformation of the rim of the cap allowing the vacuum in the preserving jar to be broken.

The present invention relates to a tool for breading a vacuum in a preserving jar closed with a screw cap, said tool comprising an oblong handle, which at one end has a portion for engaging the periphery of the cap, and a jaw for engaging the lower edge of the cap.

A tool of this kind is known from DE patent application no. 38 22 745. In this tool the portion for engaging the cap comprises two on the handle essentially perpendicular arms tapering towards the ends, and in which the edges intended to engage the cap form a small angle with each other in such a way that each arm only contacts the rounded outer rim of the cap in a single point.

When the tool is used, the jaw is advanced towards the cap, the free end of the jaw reaching under the edge of the cap while the portion with the two arms abuts the rim of the cap, the handle extending diametrically across the cap.

The handle is then pressed down against the cap to pivot about a line through the two contact points between said arms and the cap, whereby the jaw is intended to engage the edge of the cap and deform it elastically and thus break the vacuum in the jar.

The tool suffers, however, from the major drawback that the handle, in particular when used for breaking a vacuum in a jar with a comparatively big diameter, will abut the upper rim of the cap in a point diametrically opposite the jaw, before the jaw has lifted the edge of the cap sufficiently, which results in the vacuum not being broken.

On account of the shape of the two arms the tool tends to slide away from the cap during the pivoting movement, which further amplifies the above-mentioned drawback.

The tool also suffers from the disadvantage in that it is difficult to simultaneously hold the tool and to present it to the cap, as the fingers cannot grasp the handle as they would then be squeezed between the handle and the cap, when the handle is pressed against the cap.

The object of the invention is to provide a tool of the type mentioned by way of introduction, which does not have the above-mentioned drawbacks and which is designed in such a way that the user intuitively understands how to use it .

This object is met according to the invention by a tool, which is characteristic in that the portion for engaging the cap is adapted to bear on the upper surface of the cap, that the mouth of the jaw is turned away from the other end of the handle, that the free end of the jaw forms a concave arc of a circle, and in that between the handle and the jaw is a guide means in the shape o f a slot forming a concave, circular arc. In this embodiment the fingers may grasp the handle of the tool, and the end of the tool with the jaw may in a natural way be advanced towards the rim of the cap, where it is guided to the rim by the concave, circular, cylindrical guide slot, the radius of which is of the same order as the radius of commonly used caps. The circular arc formed by the free edge of the jaw likewise has a radius corresponding to the radius of the neck of the commonly used jars. This makes it possible for the jaw to reach all the way to the jar over its whole width, and it is thereby ensured that the jaw safely rests on the lower side of the rim of the cap and not only contacts the rim in a single point.

The handle is then lifted slightly thereby pivoting about the line of contact between the upper side of the cap and the portion bearing on the cap. By this movement the jaw grips the lower edge of the cap and gives it an elastic deformation sufficient for breaking the vacuum in the jar. As the tool according to the invention bears on the upper side of the cap and not like the known tool the rounded outer rim of the cap, it does not, when used, like the known tool tend to slide away from the cap.

In a preferred embodiment the portion for engaging the cap may be a plane surface in the shape of a circle segment By this embodiment a line contact is established during the pivoting of the tool between the edge of the plane surface constituting the chord in the circle segment and the upper side of the rim of the cap which is usually a plane, annular surface. Such a line contact is more gentle to the cap than the point contact occurring in case of the known tool when used.

In another embodiment the circular segment may have such a size that when the tool is used it spans over two thread sections in the screw cap. The thread on the commonly used jars is a quadruple thread in case of small jars and a sextuple thread in case of big jars. As the pitch of the thread is comparatively big, and the portion of the neck of the jar provided with threads comparatively short, each thread or thread portion only extends over a comparatively small part of the circumference of the neck. The cap does not have an actual thread, but the rim of the cap facing downwards is flanged with a view to reinforcing the rim, except for four or six sections positioned equally spaced along the circumference, where the edge forms a flap facing the centre of the cap. When screwing on the cap these flaps engage the threads of the jar and therefore act as a kind of interior threads.

Tests have shown that it is advantageous that the circle segment spans over two thread sections in the cap in order to obtain a suitable elastic deformation of the rim of the cap for breaking the vacuum in the jar. If the circle segment spans over more thread sections, the pivoting linne will, when the tool is used, be closer to the centre of the cap, and the lever between the pivoting line and the jaw will therefore become so long that a user applies too large a force to break the vacuum and counteracts this by steadying the jar with the other hand, whereby the rim becomes permanently deformed. If, however, the circle segment spans over a smaller area, for instance only a single thread section, the force applied by the user to the rim of the cap will be concentrated on a small area, and there is a risk that a permanent deformation of the rim of the cap will occur.

In a further embodiment the length of the jaw may be adjustable. Even though most jars on the market are provided with caps of standard size, caps having an extra high rim may also be found on the market. In said embodiment the tool may also be used for such jars in addition to being used for the more common jars.

The invention will now be explained in detail by means of an embodiment and with reference to the drawing, in which

FIG. 1 is a lateral sectional view of a tool according to the invention,

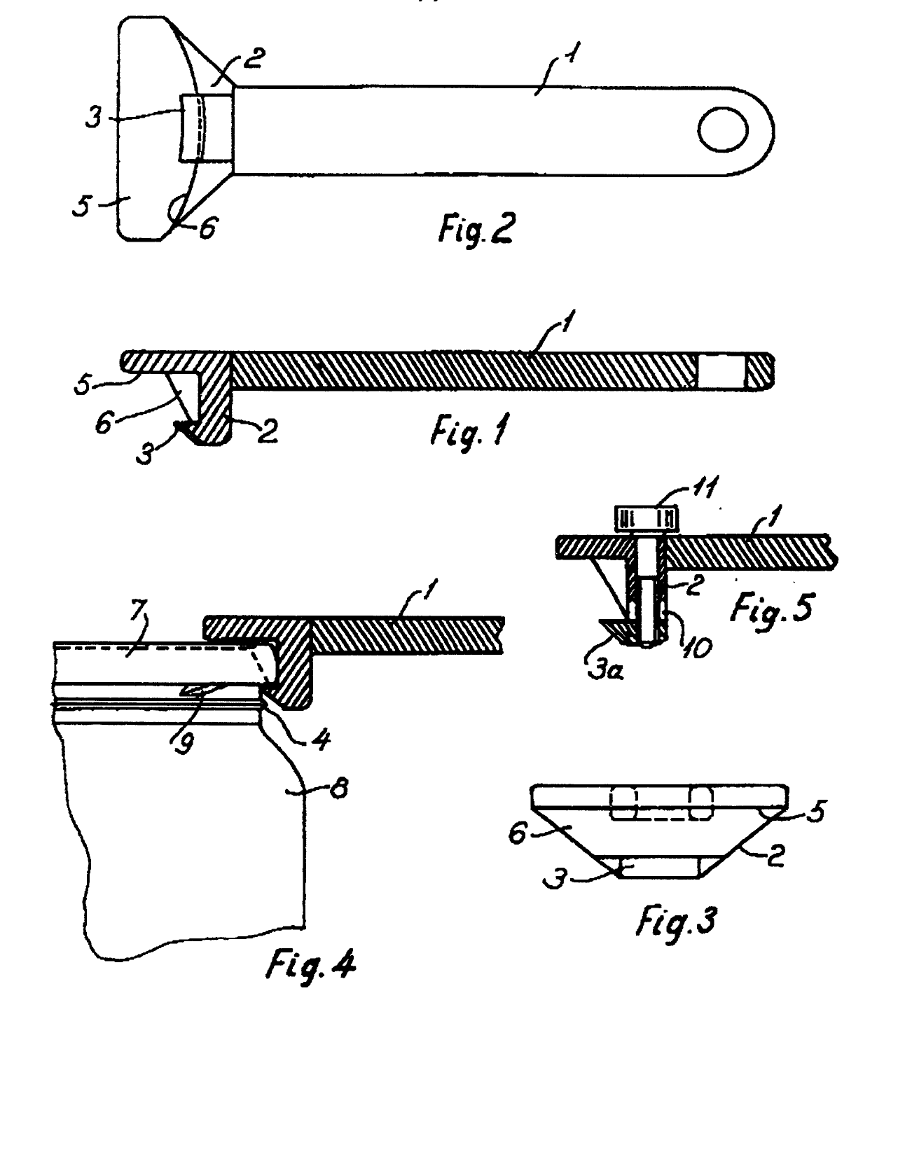

FIG. 2 is a plane view of the tool seen from below,

FIG. 3 is an end view of the tool,

FIG. 4 is a sectional view showing the tool in engagement with the cap of a jar, and

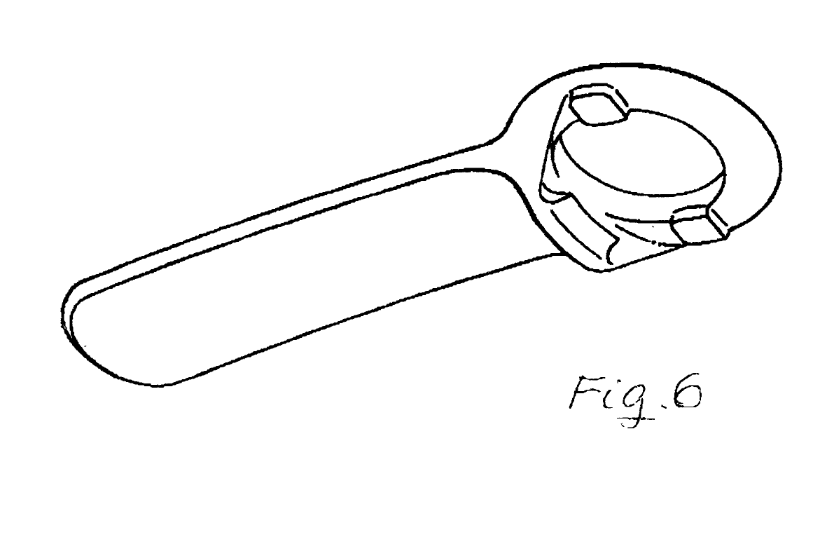

FIG. 5 is a tool with an adjustable jaw.

The tool shown in the drawing has an oblong handle 1 and a jaw 2, the free end 3 of which is formed to a concave circular arc. As best seen from FIG. 4 the under side of the jaw is bevelled, which makes it go free of the annular bead 4 normally present on preserving jars 8. Above the jaw the tool has a plane surface 5, which essentially has the shape of a circle segment, the circular boundary being formed by a circular guide slot 6 positioned in the jaw 2 between its free end 3 and the surface 5. The radius of the guide slot 6 and the jaw 2 corresponds to the radius of the biggest caps 7 and the radius of the neck of the corresponding jars 8, respectively, for which the tool is intended to be used,. The pressure surface 5 spans over the area between two thread sections in the cap 7.

As indicated by means of the hatchings in FIGS. 1 and 4, the tool may, in a not further specified way, consist of a head with a jaw, pressure surface 5 and guide 6, and a separate handle 1.

In the embodiment shown in FIG. 5 the free end of the jaw is a separate part 3a, which is displaceable in a slot 10 in the jaw 2. The part 3a is secured in the slot 10 by a threaded bolt 11, and the length of the jaw may be adjusted by turning the bolt 11.

As mentioned, it is important that the said pivoting line be located at a rather critical distance from the outer edge of the engaged area of the lid. In practice the vast majority of standard lids have an exterior diameter of 82-85 mM and a top ridge located slightly inside the periphery, as also indicated in FIG. 4. The exterior diameter of the ridge is some 77 mm, and the width thereof is about 2 mm. Thus, the pivoting line will be defined by the engagement of the opposed, foremost and outermost portions of the top plane 5 against the ridge, and it has been found that the tool operates ideally when the length of this line, measured as a chord to the ridge, is some 40-45 mm, i.e. corresponding to the radius of the lid or one sixth of the periphery of the lid. Also, as mentioned, when the glass mounting has six thread sections the said pivot line should span over two such sections, from middle to middle therof.

These measure relations are reproduced in the authentic illustration in FIG. 1, where the curvature of the abutment face 6 represents the peripheral curvature of the lid to which the tool is adapted. The length of the pivot line should be between one fifth and one seventh of the periphery of the lid, preferable close to one sixth.

In FIG. 6 is shown a modified embodiment of the tool, where the top portion 5 is designed as a ring structure, based on the fact that the middle part of the portion 5 in FIG. 1 will not at all touch the lid, located as it is in the space inside the said edge ridge of the lid. What is left to touch the top side of the lid is two opposed bosses located so as to engage the ridge of the lid, preferably with a center spacing of 38-42 mm and a width of 5-10 mm. Ideal measures, in accordance with the above considerations, are a center spacing of 40 mm and a width, when circularly shaped, of 7 mm, for cooperation with the most widely used standard lids.

1. A tool for breaking a vacuum in a preserving jar (8) closed with a screw cap (7), said tool comprisiing an oblong handle (1), which at one end has a portion (5) for engaging th periphery of the cap (7), and a jaw (2) foor engaging (the lower edge of the cap (7), characterized in that the portion (5) for engaging the cap is adapted to bear on the upper surface of the cap, that the mouth of the jaw (2) is turned away from the other end of the handle (1), that the free end (3) of the jaw (2) forms a concave arc of a circle, and in that between the handle (1) and the jaw (2) is a guide means (6) in the shape of a slot forming a concave, circular arc.

2. A tool according to claim 1, characterized in that the portion for engaging the cap (7) is a plane surface (5) in the shape of a circle segment.

3. A tool according to claim 2, characterized in that the circle segment has such a size that when the tool is used it covers two thread sections in the screw cap (7).

4. A tool according to any of the preceding claims, characterized in that the length of the jaw (2) is adjustable.

5. A tool for breaking a vacuum in a wide-mouth preserving jar closed with a screw cap, the tool comprising an oblong handle having at one end a tool head with a jaw (2,3) for engaging under the lower edge of the screw cap and a wider top portion for engaging the top side of the screw cap along a chord inside the area of engagement between the jaw and the cap edge, characterized in that the tool head is so dimensioned that the said top portion, when the tool is held in its operative position at the edge of a standard size cap, to which the tool is adapted, defines a chord of engagement having a length of approximately one sixth of the periphery of the cap, the said top portion effectively engaging the cap top side or upstanding edge rib portions thereof by substantially planar, i.e. non-sharp pressure face portions.

6. A tool according to claim 5 in which the top side of the edge lifting jaw is horizontal when the tool is held in its operative position.

7. A tool according to claim 5, in which the free front edge of the edge lifting jaw forms a concave arc of a circle having the diameter of the standard cap.

8. A tool according to claim 5, in which the edge lifting jaw is a wedge member, the lower side of which extends at an angle of approximately 45°.

9. A tool according to claim 5, in which the tool head has a forwardly facing abutment wall between the root of the jaw and the protruding top portion, this wall being shaped as a concave part-cylindrical surface having the diameter of the relevant standard lid.

10. A tool according to claim 5, in which the top portion is structured so as to have side portions which substantially flat undersides located above the engaged portions of an upstanding edge rib on the lid.

11. A tool according to claim 5, in which the top portion is designed as a plate member generally having a flat underside.

12. A tool according to claim 5, in which the length of the jaw is adjustable.
